(19) United States
(12) Patent Application Publication
(10) Pub. No.: US 2025/0243920 A1
(43) Pub. Date: Jul. 31, 2025

(54) PLATE SPRING

(71) Applicant: HONDA MOTOR CO., LTD., TOKYO (JP)

(72) Inventor: Satoshi SUGAI, WAKO-SHI (JP)

(21) Appl. No.: 19/016,333

(22) Filed: Jan. 10, 2025

(30) Foreign Application Priority Data
Jan. 26, 2024 (JP) 2024-009854

(51) Int. Cl. F16F 1/32; C25B 9/63

(52) U.S. Cl. CPC F16F 1/324; C25B 9/63; F16F 2224/0208

(57) ABSTRACT

A plate spring includes: a disc member; and a plurality of claws provided on the disc member, positioned between an outer peripheral end of the disc member and an inner peripheral end of the disc member, and arranged along a circumferential direction of the disc member, wherein each of the plurality of claws extends along a radial direction of the disc member and warps in a thickness-wise direction of the disc member.

### CROSS-REFERENCE TO RELATED APPLICATIONS

This application is based upon and claims the benefit of priority from Japanese Patent Application No. 2024-009854 filed on Jan. 26, 2024, the contents of which are incorporated herein by reference.

### BACKGROUND OF THE INVENTION

### Field of the Invention

The present disclosure relates to a plate spring.

### Description of the Related Art

JP 2019-157213 A discloses a water electrolysis device including a plate spring and a cathode power feeding body. The plate spring applies a load to the cathode power feeding body.

### SUMMARY OF THE INVENTION

Recently, a plate spring capable of applying a load (surface pressure) to an object to be pressed such as a cathode power feeding body in a better manner has been desired.

The present invention has the object of solving the aforementioned problem.

An aspect of the present disclosure is a plate spring including: a disc member; and a plurality of claws provided on the disc member, positioned between an outer peripheral end of the disc member and an inner peripheral end of the disc member, and arranged along a circumferential direction of the disc member, wherein each of the plurality of claws extends along a radial direction of the disc member and warps in a thickness-wise direction of the disc member.

According to the present invention, the plate spring can better apply a surface pressure to the object to be pressed.

The above and other objects, features, and advantages of the present invention will become more apparent from the following description when taken in conjunction with the accompanying drawings, in which a preferred embodiment of the present invention is shown by way of illustrative example.

### BRIEF DESCRIPTION OF THE DRAWINGS

FIG. 1 is a schematic view showing a water electrolysis stack according to an embodiment;

FIG. 2 is an exploded view of a unit cell included in the water electrolysis stack;

FIG. 3 is a plan view showing a plate spring and a plate member of the unit cell;

FIG. 4 is a cross-sectional view showing a part of the plate spring and a part of the plate member; and

FIG. 5 is a cross-sectional view showing a part of a plate spring and a part of a plate member according to a first modification.

### DETAILED DESCRIPTION OF THE INVENTION

### One Embodiment

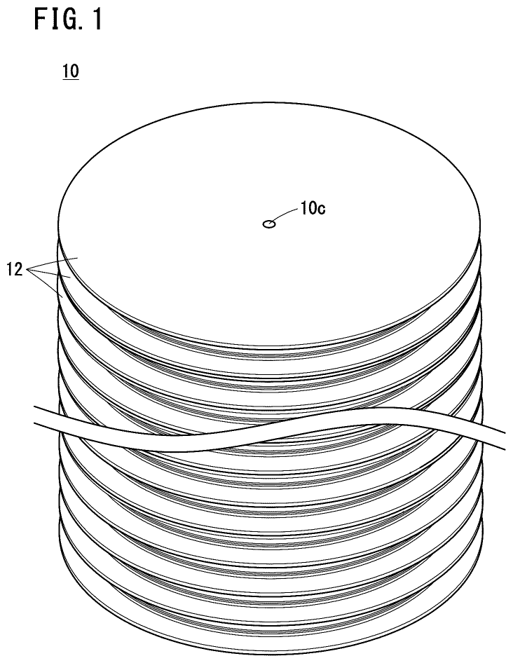

FIG. 1 is a schematic view showing a water electrolysis stack 10 according to one embodiment.

The water electrolysis stack 10 includes a plurality of stacked unit cells 12. The water electrolysis stack 10 is provided in, for example, a water electrolysis device. The water electrolysis device including the water electrolysis stack 10 is, for example, a high differential pressure water electrolysis device.

The appearance of each of the plurality of unit cells 12 is substantially disc-shaped. A hydrogen passage 10c is formed in the radial central portion of the unit cell 12. The hydrogen passage 10c extends along the stacking direction of the unit cells 12 in the electrolysis stack 10. The hydrogen (high-pressure hydrogen) generated by the water electrolysis device can be taken out from the unit cells 12 (water electrolysis stack 10) through the hydrogen passage 10c.

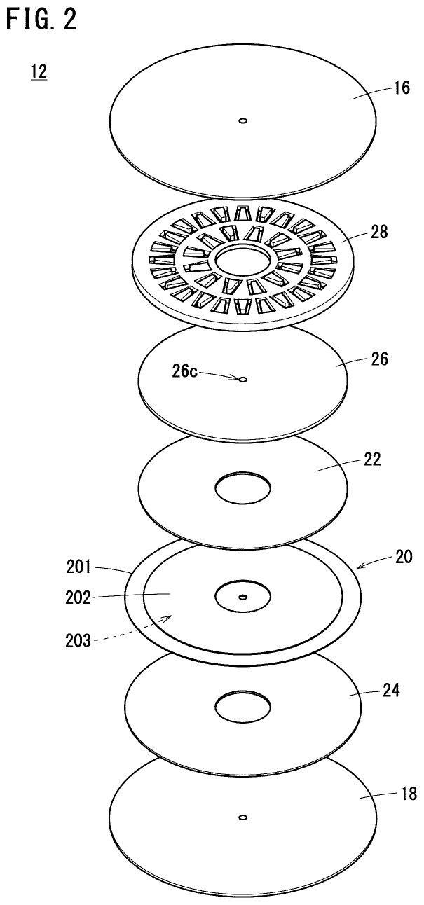

FIG. 2 is an exploded view of the unit cell 12 provided in the water electrolysis stack 10.

As shown in FIG. 2, the unit cell 12 includes a first separator 16, a second separator 18, a membrane-catalyst assembly 20, a first power feeding body 22, a second power feeding body 24, a plate member 26, and a plate spring 28. Although the unit cell 12 may include other components (for example, see JP 2019-157213), description thereof in the present embodiment will be omitted.

The first separator 16 is used as a cathode separator in the unit cell 12. On the other hand, the second separator 18 is used as an anode separator in the unit cell 12. Each of the first separator 16 and the second separator 18 is, for example, a carbon member, but may be a metal member.

The membrane-catalyst assembly 20 is an assembly positioned between the first separator 16 and the second separator 18. The membrane-catalyst assembly 20 includes a polymer electrolyte membrane (PEM) 201 and a first catalyst layer 202. The PEM 201 is a hydrocarbon-based or a fluorine-based polymer electrolyte membrane, for example. The polymer electrolyte membrane includes a solid polymer electrolyte membrane. The first catalyst layer 202 is provided on a surface of the PEM 201 facing the first separator 16. The first catalyst layer 202 contains, for example, a platinum-based catalyst. Although not specifically shown in the drawings, the membrane-catalyst assembly 20 further includes a second catalyst layer 203. The second catalyst layer 203 is provided on another surface (not shown) of the PEM 201 facing the second separator 18. The second catalyst layer 203 contains, for example, a ruthenium-based catalyst.

The membrane-catalyst assembly 20 is sandwiched between the first power feeding body 22 and the second power feeding body 24. The first power feeding body 22 is a disc-shaped cathode power feeding body disposed between the membrane-catalyst assembly 20 and the first separator 16 as the cathode separator. On the other hand, the second power feeding body 24 is a disc-shaped anode power feeding body disposed between the membrane-catalyst assembly 20 and the second separator 18 as the anode separator.

The plate member 26 is a disc-shaped member disposed between the first power feeding body 22 and the first separator 16. The plate member 26 is, for example, a conductive member (conductive sheet) formed of metal (alloy). The material of the plate member 26 includes, for example, a steel use stainless (SUS) alloy, but is not limited thereto. The radial direction of the plate member 26 is the same as the radial direction of the unit cell 12 described above. A through hole 26c is formed at the central portion of the plate member 26 in the radial direction of the plate member 26. The through hole 26c penetrates the plate member 26 along the stacking direction of the plurality of unit cells 12. The through hole 26c may form a part of the hydrogen passage 10c.

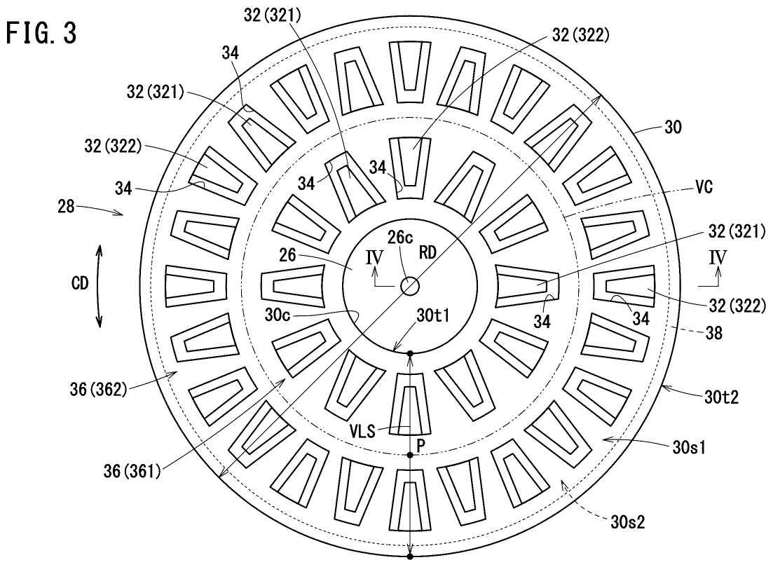

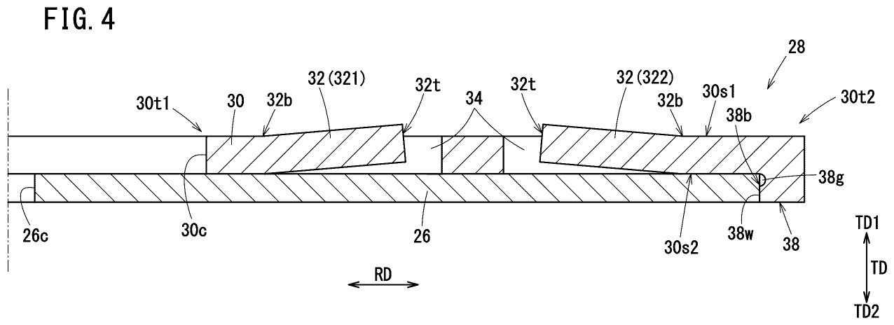

FIG. 3 is a plan view showing the plate spring 28 and the plate member 26 provided in the unit cell 12. The plan view shown in FIG. 3 is a diagram viewed in the thickness-wise direction TD (view in the thickness-wise direction) to be described later. FIG. 4 is a cross-sectional view showing a part of the plate spring 28 and a part of the plate member 26. A cross section taken along line IV-IV of FIG. 3 is shown in FIG. 4.

The plate spring 28 is an urging member provided between the plate member 26 and the first separator 16. The plate spring 28 may be formed of metal (alloy). The alloy is, for example, SUS alloy, but is not limited thereto. The plate spring 28 includes a disc member 30 and a plurality of claws 32 provided to the disc member 30.

The disc member 30 has a disc shape concentric with the plate member 26. The radial direction RD of the disc member 30 is the same as the radial direction of the unit cell 12 described above. As such, the radial direction RD is also the same as the radial direction of the plate member 26 described above. A center hole 30c is formed in the central portion of the disc member 30 in the radial direction RD. The center hole 30c defines an inner peripheral end 30t1 of the disc member 30 in the radial direction RD.

The disc member 30 has a first surface 30s1 and a second surface 30s2. The first surface 30s1 is a surface of the disc member 30 that faces in the first direction TD1. The first direction TD1 is a direction along the thickness-wise direction TD of the disc member 30. On the other hand, the second surface 30s2 is a surface of the disc member 30 that faces in the second direction TD2. The second direction TD2 is a direction opposite to the first direction TD1.

The thickness-wise direction TD is the same direction as the stacking direction of the unit cells 12 in the water electrolysis stack 10 (FIG. 1). The first direction TD1 is the same as a direction from the second separator 18 (anode separator) toward the first separator 16 (cathode separator).

The plurality of claws 32 are positioned between an outer peripheral end 30t2 and the inner peripheral end 30t1 of the disc member 30 in the radial direction RD. That is, as shown in FIGS. 3 and 4, a plurality of holes 34 are formed in the disc member 30. Each of the plurality of claws 32 may be provided inside each of the plurality of holes 34. The plurality of holes 34 are provided so as to surround the center hole 30c along the circumferential direction CD of the disc member 30. Therefore, the plurality of claws 32 provided inside the plurality of holes 34 also surround the center hole 30c along the circumferential direction CD.

The plurality of claws 32 form a plurality of claw groups 36. Each of the plurality of claw groups 36 is formed of a plurality of claws 32 arranged annularly along the circumferential direction CD. The plurality of claw groups 36 include an inner claw group 361 and an outer claw group 362. The outer claw group 362 is positioned radially outward of the inner claw group 361. The radially outward direction in the disc member 30 is a direction opposite to the direction from the inner claw group 361 to the center hole 30c in the radial direction RD.

FIG. 3 shows a virtual line segment VLS and a virtual circle VC. The virtual line segment VLS is the shortest line segment that virtually connects the outer peripheral end 30t2 and the inner peripheral end 30t1 along the radial direction RD. The virtual circle VC is concentric with the disc member 30 and passes through the midpoint P of the virtual line segment VLS. The circumferential direction of the virtual circle VC is the same as the circumferential direction CD of the disc member 30. The outer claw group 362 is positioned radially outward of the virtual circle VC. On the other hand, the inner claw group 361 is positioned radially inward of the virtual circle VC. However, one of the inner claw group 361 and the outer claw group 362 may overlap the virtual circle VC in a plan view in the thickness-wise direction TD (thickness-wise direction view). The radially inward direction is a direction opposite to the radially outward direction described above.

At least one claw 32 belonging to the inner claw group 361 is preferably arranged adjacent to the claw 32 belonging to the outer claw group 362 along the radial direction RD, but is not limited thereto. The outer claw group 362 may include claws 32 adjacent to the claws 32 belonging to the inner claw group 361 along the radial direction RD, and claws 32 not adjacent to the claws 32 belonging to the inner claw group 361 along the radial direction RD. In this case, the claws 32 of the outer claw group 362 positioned adjacent to the claws 32 of the inner claw group 361 along the radial direction RD and the claws 32 of the outer claw group 362 not positioned adjacent to the claws 32 belonging to the inner claw group 361 along the radial direction RD may be alternately arranged along the circumferential direction CD (FIG. 3).

Although not shown, the plurality of claws 32 may include three or more claw groups 36. In other words, two or more outer claw groups 362 may be provided for one inner claw group 361. In such a case, one claw group 36 of the claw groups 36 may overlap the virtual circle VC as viewed in the thickness-wise direction.

Each of the plurality of claws 32 includes a base end portion 32b and a tip end portion 32t. The base end portion 32b is one end portion of the claw 32 in the radial direction RD. The base end portion 32b is connected to the disc member 30 (the inner wall of the hole 34). The tip end portion 32t is the other end portion of the claw 32 in the radial direction RD opposite to the base end portion 32b. As shown in FIG. 3, each of the plurality of claws 32 preferably has a shape tapered from the base end portion 32b toward the tip end portion 32t.

The plurality of claws 32 include a plurality of outward claws 321 and a plurality of inward claws 322. The outward claw 321 has its tip end portion 32t positioned radially outward of its base end portion 32b. In contrast, the inward claw 322 has its tip end portion 32t positioned radially inward of its base end portion 32b.

As shown in FIG. 3, the plurality of outward claws 321 and the plurality of inward claws 322 are alternately arranged along the circumferential direction CD. More specifically, the plurality of claws 32 belonging to the inner claw group 361 include a plurality of outward claws 321 and a plurality of inward claws 322. The plurality of outward claws 321 belonging to the inner claw group 361 and the plurality of inward claws 322 belonging to the inner claw group 361 are alternately arranged along the circumferential direction CD. The plurality of claws 32 belonging to the outer claw group 362 described above also include a plurality of outward claws 321 and a plurality of inward claws 322. The plurality of outward claws 321 belonging to the outer claw group 362 and the plurality of inward claws 322 belonging to the outer claw group 362 are alternately arranged along the circumferential direction CD. In the present embodiment, the plurality of inward claws 322 belonging to the outer claw group 362 are adjacent to the claws 32 belonging to the inner claw group 361 along the radial direction RD, but the present invention is not limited thereto.

As shown in FIG. 4, the plurality of claws 32 are warped in the thickness direction TD. More particularly, the claws 32 are warped such that the tip end portions 32t of the claws 32 protrude from the disc member 30 (the holes 34) along the thickness-wise direction TD. It is preferable that all of the plurality of claws 32 provided on the disc member 30 are warped in the first direction TD1.

The plate spring 28 further includes an annular portion 38. The annular portion 38 extends in the second direction TD2 at the outer peripheral end 30t2. The annular portion 38 surrounds the disc member 30 along the circumferential direction CD. For example, the annular portion 38 is formed by partially bending the base of the disc member 30 in the second direction TD2. In this manner, the annular portion 38 is integral with the disc member 30. As such, the annular portion 38 is formed of the same material as the disc member 30.

The annular portion 38 has an inner wall 38w. The inner wall 38w of the annular portion 38 faces radially inward. The inner wall 38w extends from the disc member 30 along the second direction TD2. An annular groove 38g is formed in a base end 38b of the inner wall 38w extending along the second direction TD2. The annular groove 38g is a bent portion formed in the above-described base as the disc member 30 is bent to form the annular portion 38. That is, partially bending the disc member 30 may form the annular groove 38g.

The plate member 26 as described above is disposed at a position in the second direction TD2 with respect to the disc member 30. The annular portion 38 surrounds the plate member 26 along the circumferential direction CD. The inner wall 38w may abut against the plate member 26.

The plate spring 28 having the above-described configuration can achieve the following effects.

The plate spring 28 includes the disc member 30. The disc member 30 is provided with a plurality of claws 32. Each of the plurality of claws 32 extends along the radial direction RD of the disc member 30 and is warped in the thickness direction TD of the disc member 30. The claws 32 are warped, for example, in the first direction TD1. Thus, the tip end portions 32t of the claws 32 can be pushed in the second direction TD2 by a member disposed on the first direction TD1 side of the plate spring 28. For example, the tip end portions 32t of the plurality of claws 32 may be pushed by the first separator 16. Thus, the plate spring 28 can apply a load (surface pressure) to the object to be pressed that is disposed on the second direction TD2 side with respect to the plate spring 28 via the base end portions 32b of the plurality of claws 32 and the disc member 30 connected to the base end portions 32b. The object to be pressed is, for example, the first power feeding body 22. The plate spring 28 can apply a surface pressure to the first power feeding body 22 via the plate member 26.

According to the present embodiment, the plurality of claws 32 extending along the radial direction RD are arranged along the circumferential direction CD. Thus, the plurality of base end portions 32b are arranged in a sufficiently dispersed manner as viewed in the thickness-wise direction. The base end portions 32b can apply a relatively large surface pressure to the object to be pressed. Since the plurality of base end portions 32b are arranged in a sufficiently dispersed manner, variations in the surface pressure as viewed in the thickness-wise direction are reduced. That is, the surface pressure distribution as viewed in the thickness direction can be made uniform. Since the surface pressure distribution is made uniform, for example, water electrolysis is suitably performed in a water electrolysis device including a water electrolysis stack 10.

Each of the plurality of claws 32 warps in the first direction TD1. Since all the claws 32 warp in the first direction TD1, all the claws 32 can apply forces in the second direction TD2 to the disc member 30. This further reduces the variations in the surface pressure applied in the second direction TD2 as viewed in the thickness-wise direction.

The plate spring 28 includes an annular portion 38. The annular portion 38 extends in the second direction TD2 at the outer peripheral end 30t2. The annular portion 38 suppresses displacement of the outer peripheral end 30t2 of the disc member 30 along the thickness-wise direction TD. Thus, the plate spring 28 can favorably apply the surface pressure to the object to be pressed over the entire disc member 30 as viewed in the thickness direction. That is, as described above, the disc member 30 receives a force in the second direction TD2 via the base end portions 32b of the claws 32. The base end portions 32b are positioned between the inner peripheral end 30t1 and the outer peripheral end 30t2 of the disc member 30. In the case where the disc member 30 is displaced (elastically deformed) in response to the force applied in the second direction TD2 and received via the base end portions 32b, there is a concern that the outer peripheral end 30t2 of the disc member 30 may be displaced in the first direction TD1. In such a situation, the outer peripheral end 30t2 may not be able to favorably apply the surface pressure to the object to be pressed. In this respect, the annular portion 38 functions as a thick portion of the disc member 30. The annular portion 38 as the thick portion suppresses the above-mentioned displacement of the outer peripheral end 30t2 in the thickness-wise direction TD. Thus, the plate spring 28 can favorably apply the surface pressure to the object to be pressed over the entire disc member 30 as viewed in the thickness direction.

As described above, the plate member 26 is disposed on the second direction TD2 side with respect to the second surface 30s2 of the disc member 30. The plate member 26 has a disc shape concentric with the disc member 30. The annular portion 38 surrounds the plate member 26 along the circumferential direction CD. Thus, the plate member 26 is easily positioned with respect to the plate spring 28 owing to the annular portion 38.

The annular portion 38 is integrated with the disc member 30. The annular portion 38 may be formed by partially bending the base (outer peripheral end 30t2) of the disc member 30. The annular portion 38 formed in this manner can suppress an increase in the number of components of the plate spring 28. The annular portion 38 formed by partially bending the disc member 30 may have an annular groove 38g along the circumferential direction CD.

The plurality of claws 32 include outward claws 321 and inward claws 322. The outward claws 321 and the inward claws 322 are alternately arranged along the circumferential direction CD. Thus, the plurality of base end portions 32b are arranged in a more sufficiently dispersed manner in the plan view of the plate spring 28. As a result, the variations in the surface pressure applied to the pressed body by the plate spring 28 are further reduced.

Each of the plurality of claws 32 has a shape tapered from the base end portion 32b toward the tip end portion 32t. This makes it possible to arrange a larger number of claws 32 along the circumferential direction CD while ensuring the thickness of the claws 32 and the interval between two claws 32 adjacent to each other along the circumferential direction CD. As a result, the variations in the surface pressure applied to the object to be pressed by the plate spring 28 are further reduced.

The plurality of claws 32 include an inner claw group 361 and an outer claw group 362. Thus, the plurality of claws 32 are arranged along the radial direction RD. As a result, the plate spring 28 can apply a more uniform surface pressure to the object to be pressed over the entire disc member 30 in the radial direction RD.

At least one claw 32 belonging to the inner claw group 361 is adjacent to the claw 32 belonging to the outer claw group 362 along the radial direction RD. Since the plurality of claws 32 are arranged along the radial direction RD, the variations in the surface pressure applied to the object to be pressed by the plate spring 28 are further reduced in the radial direction RD. In this case, the claws 32 of the outer claw group 362 positioned adjacent to the claws 32 of the inner claw group 361 along the radial direction RD and the claws 32 of the outer claw group 362 not adjacent to the claws 32 belonging to the inner claw group 361 along the radial direction RD may be alternately arranged along the circumferential direction CD. This further reduces the variations, in the radial direction RD, in the surface pressure applied to the object to be pressed by the plate spring 28. The claws 32 of the outer claw group 362 adjacent to the claws 32 of the inner claw group 361 along the radial direction RD are preferably the inward claws 322. That is, the tip end portion 32t of the claw 32 of the outer claw group 362 adjacent to the claw 32 of the inner claw group 361 along the radial direction RD is preferably positioned on the radially inner side with respect to the base end portion 32b of the claw 32. This further reduces the variations, in the radial direction RD, in the surface pressure applied to the object to be pressed by the plate spring 28.

The one embodiment may be modified in the following manner.

### Modified Embodiment 1

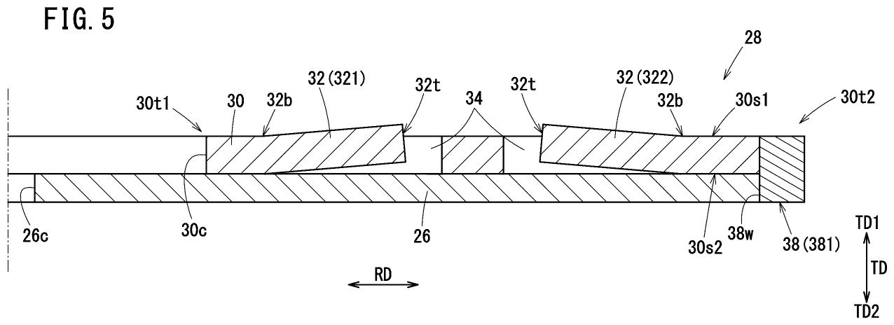

FIG. 5 is a cross-sectional view showing a part of a plate spring 28 and a part of a plate member 26 according to a first modification. The cross-sectional view shown in FIG. 5 corresponds to that shown in FIG. 4.

The annular portion 38 may be formed by an annular member 381 that is a separate body from the disc member 30. The annular member 381 is fitted on the outer peripheral end 30t2. Therefore, the annular member 381 abuts on the outer peripheral end 30t2. Thus, the annular member 381 suppresses displacement of the outer peripheral end 30t2 along the thickness-wise direction TD. Thus, as in the one embodiment, the plate spring 28 can favorably apply the surface pressure to the object to be pressed over the entire disc member 30 as viewed in the thickness-wise direction.

The annular member 381 may extend from the disc member 30 to the plate member 26 along the second direction TD2. Thus, as in the one embodiment, the plate member 26 can be easily positioned by the annular portion 38 (the annular member 381).

### Modified Embodiment 2

The annular portion 38 may extend from the disc member 30 (outer peripheral end 30t2) to the first power feeding body 22 along the second direction TD2. In this case, the annular portion 38 can further surround the first power feeding body 22. Since the first power feeding body 22 is surrounded by the annular portion 38, not only the positioning of the plate member 26 but also the positioning of the first power feeding body 22 can be easily achieved.

According to the embodiment and the modifications, the plate spring 28 can more favorably apply the surface pressure to the object to be pressed.

The following supplementary notes are further disclosed in relation to the above embodiment and modifications.

### Supplementary Note 1

The plate spring (28) according to the present disclosure includes: the disc member (30); and the plurality of claws (32) provided on the disc member, positioned between the outer peripheral end (30t2) of the disc member and the inner peripheral end (30t1) of the disc member, and arranged along the circumferential direction (CD) of the disc member, wherein each of the plurality of claws extends along the radial direction (RD) of the disc member and warps in a thickness-wise direction (TD) of the disc member. In this manner, variations decrease in the surface pressure applied by the plate spring to the object to be pressed.

### Supplementary Note 2

In the plate spring according to Supplementary Note 1, the disc member has the first surface (30s1) facing the first direction (TD1) of the thickness-wise direction and the second surface (30s2) facing the second direction (TD2) opposite to the first direction, and each of the plurality of claws may warp in the first direction. In this manner, variations further decrease in the surface pressure applied in the second direction by the plate spring to the object to be pressed.

### Supplementary Note 3

The plate spring according to Supplementary Note 2 may further include the annular portion (38) extending from the outer peripheral end of the disc member along the second direction and surrounding the plurality of claws along the circumferential direction. In this manner, variations further decrease in the surface pressure applied by the plate spring to the object to be pressed.

### Supplementary Note 4

In the plate spring according to Supplementary Note 3, the annular portion may be integrated with the disc member. Such an annular portion can be formed while suppressing an increase in the number of components of the plate spring.

### Supplementary Note 5

In the plate spring according to Supplementary Note 3, the annular portion may be formed by the annular member (381) which is separate from the disc member and which abuts against the outer peripheral end of the disc member. In this manner, variations further decrease in the surface pressure applied by the plate spring to the object to be pressed.

### Supplementary Note 6

In the plate spring according to any one of Supplementary Notes 1 to 5, each of the plurality of claws may include the base end portion (32b) which is an end portion connected to the disc member in the radial direction, and the tip end portion (32t) which is an end portion in the radial direction and is different from the base end portion, the plurality of claws may include the outward claws (321) each of which has the tip end portion positioned outward in the radial direction of the disc member with respect to the base end portion, and the inward claws (322) each of which has the tip end portion positioned inward in the radial direction of the disc member with respect to the base end portion, and the outward claws and the inward claws may be alternately arranged along the circumferential direction. In this manner, variations further decrease in the surface pressure applied by the plate spring to the object to be pressed.

### Supplementary Note 7

In the plate spring according to the Supplementary Note 6, each of the plurality of claws may have a shape tapered from the base end portion toward the tip end portion. In this manner, variations further decrease in the surface pressure applied by the plate spring to the object to be pressed.

### Supplementary Note 8

The plate spring according to any one of Supplementary Notes 1 to 5 may further include the inner claw group (361) including some of the plurality of claws arranged annularly along the circumferential direction, and the outer claw group (362) disposed outward of the inner claw group in the radial direction of the disc member and including some of the plurality of claws arranged annularly along the circumferential direction. In this manner, the plate spring can apply a more uniform surface pressure to the object to be pressed over the entire disc member in the radial direction.

### Supplementary Note 9

In the plate spring according to Supplementary Note 8, at least one of the claws belonging to the inner claw group may be adjacent to at least one of the claws belonging to the outer claw group along the radial direction. In this manner, variations in the radial direction further decrease in the surface pressure applied by the plate spring to the object to be pressed.

### Supplementary Note 10

In the plate spring according to Supplementary Note 9, the claws belonging to the outer claw group and adjacent to the claws belonging to the inner claw group along the radial direction, and the claws belonging to the outer claw group and not adjacent to the claws belonging to the inner claw group along the radial direction may be alternately arranged along the circumferential direction. In this manner, variations in the radial direction further decrease in the surface pressure applied by the plate spring to the object to be pressed.

### Supplementary Note 11

In the plate spring according to Supplementary Note 10, each of the claws belonging to the outer claw group and adjacent to the claws belonging to the inner claw group along the radial direction may include the base end portion (32b) which is an end portion connected to the disc member in the radial direction, and the tip end portion (32t) which is an end portion in the radial direction, is different from the base end portion and is positioned on an inner side in the radial direction of the disc member with respect to the base end portion. In this manner, variations in the radial direction further decrease in the surface pressure applied by the plate spring to the object to be pressed.

It should be noted that the present invention is not limited to the disclosure described above, and various additional or alternative configurations could be adopted therein without departing from the essence and gist of the present disclosure.

1. A plate spring comprising:
a disc member; and
a plurality of claws provided on the disc member, positioned between an outer peripheral end of the disc member and an inner peripheral end of the disc member, and arranged along a circumferential direction of the disc member, wherein
each of the plurality of claws extends along a radial direction of the disc member and warps in a thickness-wise direction of the disc member.

2. The plate spring according to claim 1, wherein
the disc member has a first surface facing a first direction of the thickness-wise direction and a second surface facing a second direction opposite to the first direction, and
each of the plurality of claws warps in the first direction.

3. The plate spring according to claim 2, further comprising:
an annular portion extending from the outer peripheral end of the disc member along the second direction and surrounding the plurality of claws along the circumferential direction.

4. The plate spring according to claim 3, wherein
the annular portion is integrated with the disc member.

5. The plate spring according to claim 3, wherein
the annular portion is formed by an annular member which is separate from the disc member and which abuts against the outer peripheral end of the disc member.

6. The plate spring according to claim 1, wherein
each of the plurality of claws includes a base end portion which is an end portion connected to the disc member in the radial direction, and a tip end portion which is an end portion in the radial direction and is different from the base end portion,
the plurality of claws include outward claws each of which has the tip end portion positioned outward in the radial direction of the disc member with respect to the base end portion, and inward claws each of which has the tip end portion positioned inward in the radial direction of the disc member with respect to the base end portion, and
the outward claws and the inward claws are alternately arranged along the circumferential direction.

7. The plate spring according to claim 6, wherein
each of the plurality of claws has a shape tapered from the base end portion toward the tip end portion.

8. The plate spring according to claim 1, further comprising:
an inner claw group including some of the plurality of claws arranged annularly along the circumferential direction, and
an outer claw group disposed outward of the inner claw group in the radial direction of the disc member and including some of the plurality of claws arranged annularly along the circumferential direction.

9. The plate spring according to claim 8, wherein
at least one of the claws belonging to the inner claw group is adjacent to at least one of the claws belonging to the outer claw group along the radial direction.

10. The plate spring according to claim 9, wherein
the claws belonging to the outer claw group and adjacent to the claws belonging to the inner claw group along the radial direction, and the claws belonging to the outer claw group and not adjacent to the claws belonging to the inner claw group along the radial direction are alternately arranged along the circumferential direction.

11. The plate spring according to claim 10, wherein
each of the claws belonging to the outer claw group and adjacent to the claws belonging to the inner claw group along the radial direction has a base end portion which is an end portion connected to the disc member in the radial direction, and a tip end portion which is an end portion in the radial direction, is different from the base end portion and is positioned on an inner side in the radial direction of the disc member with respect to the base end portion.
